(19) United States
(12) Patent Application Publication
(10) Pub. No.: US 2026/0129627 A1
(43) Pub. Date: May 7, 2026

(54) METHODS AND SYSTEMS FOR MANAGING A PLURALITY OF BANDWIDTH PARTS IN A WIRELESS COMMUNICATION SYSTEM

(71) Applicant: Samsung Electronics Co., Ltd., Suwon-si (KR)

(72) Inventors: Shyamal DHUA, Bangalore (IN); Ram ADITYA S, Bangalore (IN); Animesh KUMAR, Bangalore (IN); Ashok Kumar Reddy CHAVVA, Bangalore (IN); Vimal Bastin EDWIN JOSEPH, Bangalore (IN); Kisuk JUN, Suwon-si (KR)

(21) Appl. No.: 19/436,424

(22) Filed: Dec. 30, 2025

Related U.S. Application Data
(63) Continuation of application No. PCT/KR2024/012955, filed on Aug. 29, 2024.

(30) Foreign Application Priority Data
Aug. 30, 2023 (IN) 202341058251
Dec. 1, 2023 (IN) 202341082007
Aug. 26, 2024 (IN) 2023 41058251

(51) Int. Cl. H04W 72/0453

(52) U.S. Cl. CPC H04W 72/0453

(57) ABSTRACT

A method performed by a base station is provided. The method includes identifying at least one of a plurality of bandwidth parts (BWP) level metrics and a plurality of user equipment (UE) level metrics for each of a plurality of BWPs for a first time window in corresponding BWP from among the plurality of BWPs, determining a BWP assignment policy based on the identified at least one of the plurality of BWP level metrics and the plurality of UE level metrics, and assigning for a second time window after the first time window, each of a plurality of UEs to each of the BWPs based on the determined BWP assignment policy.

### CROSS-REFERENCE TO RELATED APPLICATION(S)

This application is a continuation application, claiming priority under 35 U.S.C. § 365(c), of an International application No. PCT/KR2024/012955, filed on Aug. 29, 2024, which is based on and claims the benefit of an Indian Provisional patent application No. 202341058251, filed on Aug. 30, 2023, in the Indian Intellectual Property Office, and of an Indian Patent Application number 202341082007, filed on Dec. 1, 2023, in the Indian Intellectual Property Office, and of an Indian Complete patent application No. 202341058251, filed on Aug. 26, 2024, in the Indian Intellectual Property Office, the disclosure of each of which is incorporated by reference herein in its entirety.

### BACKGROUND

### 1. Field

The disclosure relates to a wireless communication systems. More particularly, the disclosure relates to systems and methods for managing a plurality of bandwidth parts (BWPs) in a wireless communication system.

### 2. Description of Related Art

With the advancements in wireless technology and communication systems, the demand for wireless data traffic has increased since the deployment of 4^{th}-generation (4G) networks. To meet such demand for wireless data traffic, efforts have been made to develop 5^{th}-generation (5G) networks.

The 5G networks have emerged as the next generation of cellular networks, offering higher data speeds, lower latency, and increased capacity compared to previous generations. To further enhance the capabilities of 5G, the 3^{rd} generation partnership project (3GPP) proposed the expansion of new radio (NR) into NR-unlicensed (NR-U) spectrum at 5 and 6 Gigahertz (GHz) bands and millimeter wave (mmWave) operations above 60 GHz.

Energy efficiency is a key performance indicator in 5G and beyond, essential for supporting various use cases like enhanced mobile broadband (eMBB), massive machine type communications (mMTC), and ultra-reliable and low latency communications (URLLC). Further, battery life plays a crucial role in user experience, and enhancing the performance of user equipment (UE) without compromising battery life is a challenging task.

In release 15 (e.g., TS 38.300 and TS 38.211), 3GPP introduced bandwidth part (BWP) in NR, in order to serve different UE requirements, such as power saving, differing traffic requirements like higher/lower data rate, delay sensitivity, service type, or the like, at a more granular level. A BWP is a contiguous set of resource blocks (RBs) within the wider total carrier bandwidth, with specific parameters like numerology, subcarrier spacing, RB size width, or the like.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for managing a plurality of bandwidth parts (BWPs) in a wireless communication system.

Additional aspects will be set forth in part in the description which follows and, in part, will be apparent from the description, or may be learned by practice of the presented embodiments.

In accordance with an aspect of the disclosure, a method performed by a base station in a wireless communication system is provided. The method includes identifying at least one of a plurality of BWP level metrics and a plurality of user equipment (UE) level metrics for each of the plurality of BWPs for a current time window in the corresponding BWP among the plurality of BWPs, determining a BWP assignment policy based on the identified at least one of the plurality of BWP level metrics and the plurality of UE level metrics, assigning and assigning for a second time window after the first time window, each of a plurality of UEs to each of the BWPs based on the determined BWP assignment policy.

In accordance with another aspect of the disclosure, a base station is provided. The base station includes memory, including one or more storage media, storing instructions, and at least one processor communicatively coupled to the memory, wherein the instructions, when executed by the at least one processor individually or collectively, cause the base station to identify at least one of a plurality of BWP level metrics and a plurality of UE level metrics for each of the plurality of BWPs for a first time window in corresponding BWP from among the plurality of BWPs, determine a BWP assignment policy based on the identified at least one of the plurality of BWP level metrics and the plurality of UE level metrics, assign, for a second time window after the first time window, each of a plurality of UEs to each of the BWPs based on the determined BWP assignment policy.

In accordance with another aspect of the disclosure, one or more non-transitory computer-readable storage media storing one or more computer programs including computer-executable instruction that, when executed by at least one processor of a base station in a wireless communication system individually or collectively, cause the base station to perform operations are provided. The operations include identifying at least one of a plurality of bandwidth part (BWP) level metrics and a plurality of user equipment (UE) level metrics for each of a plurality of BWPs for a first time window in corresponding BWP from among the plurality of BWPs, determining a BWP assignment policy based on the identified at least one of the plurality of BWP level metrics and the plurality of UE level metrics, and assigning for a second time window after the first time window, each of a plurality of UEs to each of the BWPs based on the determined BWP assignment policy.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a bandwidth part (BWP) allocation according to an embodiment of the disclosure;

FIG. 2 illustrates a LBT protocol for shared channels according to an embodiment of the disclosure;

FIG. 3 illustrates a multipath reception of signals at a g NodeB (gNB) according to an embodiment of the disclosure;

FIG. 4 illustrates time varying impulse response of a multipath channel according to an embodiment of the disclosure;

FIG. 5 illustrates different BLER performances in each BWP in a new radio (NR) licensed system according to an embodiment of the disclosure;

FIG. 6 illustrates BWP allocation in a wireless communication unlicensed system according to an embodiment of the disclosure;

FIG. 7 illustrates a wireless communication system that supports managing a plurality of BWPs according to an embodiment of the disclosure;

FIG. 8 illustrates a method for managing a plurality of BWPs in the wireless communication system, according to an embodiment of the disclosure;

FIG. 9 illustrates a timing diagram for managing the plurality of BWPs in the wireless communication system, according to an embodiment of the disclosure;

FIG. 10 illustrates an AI model for managing the plurality of BWPs in the wireless communication system, according to an embodiment of the disclosure;

FIG. 11 illustrates a BWP allocation for a wireless communication licensed system, according to an embodiment of the disclosure;

FIG. 12 illustrates a BWP allocation for a wireless communication unlicensed system, according to an embodiment of the disclosure;

FIG. 13 illustrates a block diagram of a system for managing the plurality of BWPs in the wireless communication system, according to an embodiment of the disclosure;

FIGS. 14A and 14B illustrate a comparison of BWP assignment in the unlicensed wireless communication system, according to various embodiments of the disclosure; and

FIGS. 15A and 15B illustrate a comparison of BWP assignment in the licensed wireless communication, according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It will be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more systems or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

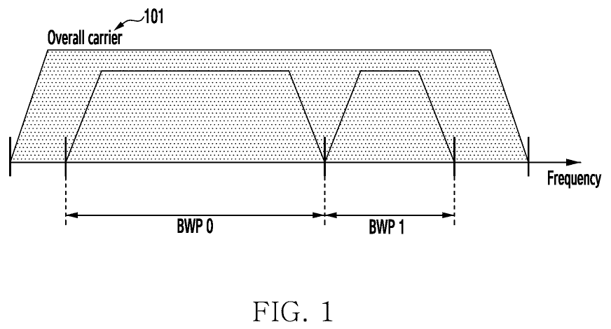

FIG. 1 illustrates a bandwidth part (BWP) allocation according to an embodiment of the disclosure.

Referring to FIG. 1, an overall carrier 101 is divided into BWP0, BWP1, and so on. Each parameter can be set according to the type of services the BWP may offer a UE. At a given time, the UE can have/be assigned to one active BWP in uplink (UL) and downlink (DL) each. NR also supports BWP adaptation, where the UE can switch/be reassigned to different BWPs, depending on the requirement. For example, when the UE is already connected and active, the main method of BWP switching/reassignment is downlink control information (DCI) based switching. This has low overhead (1 slot switch delay for subcarrier spacing (SCS) 15 KHz and 2 slots 30 KHz SCS) compared to the other switching methods (3GPP TS 38.133).

The 5G networks have emerged as the next generation of cellular networks, offering higher data speeds, lower latency, and increased capacity compared to previous generations. NR licensed (NR-L) spectrum is exclusively reserved for a given operator and there is no coexistence with any other kind of traffic from other operators/technologies. In order to enhance 5G capability, 3GPP Release 16 proposed the expansion of NR into the shared unlicensed spectrum (NR-U) at 5 and 6 GHz bands and mmWave operations above 60 GHz. NR-U is a cost-effective (no license costs) option with many use cases, that can greatly enhance network performance by increasing the data rate, lowering delay, improving quality of service (QoS) for the users, increasing coverage, or the like. Compared to the licensed NR case, there is a challenge as NR-U must coexist with incumbent technologies like Wi-Fi, LTE-LAA, traffic from other operators, or the like, which also use the same unlicensed channels. Based on long term evolution (LTE) license assisted access's (LAA) method of accessing the shared spectrum (3GPP TR 36.889 (V13.0.0)), NR must also follow a similar listen before talk (LBT) protocol whenever it wants to gain access to the channel for transmission.

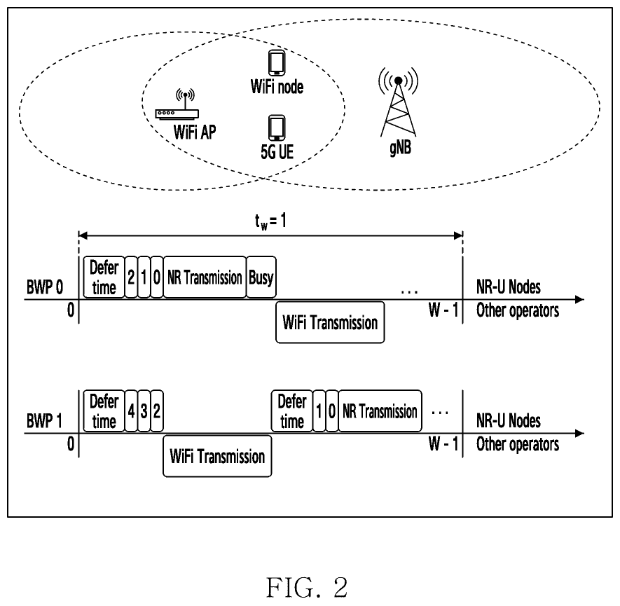

FIG. 2 illustrates a LBT protocol for shared channels, according to an embodiment of the disclosure.

Referring to FIG. 2, the UE performs an initial clear channel assessment (ICCA) (defer time in FIG. 2), which is a fixed period for which the channel is sensed. Once the channel is sensed as free during ICCA, a back-off counter value c, is sampled from a range [0, CW], CW is contention window size. The UE performs extended clear channel assessment (ECCA), i.e., senses the channel for c slots, and when the counter reaches 0, starts NR transmission and occupies the channel for a period called maximum channel occupancy time (MCOT). This is considered an LBT success.

If the Retx/negative acknowledgment (NACK) percentage is above a threshold, then CW is updated to 2×CW, i.e., double the contention window size, and the steps are repeated. This way of accessing the channel causes uncertainty in scheduling and greatly reduces the network performance affecting the throughput and delay. This degradation is mainly dependent on the collisions/congestion due to coexisting traffic.

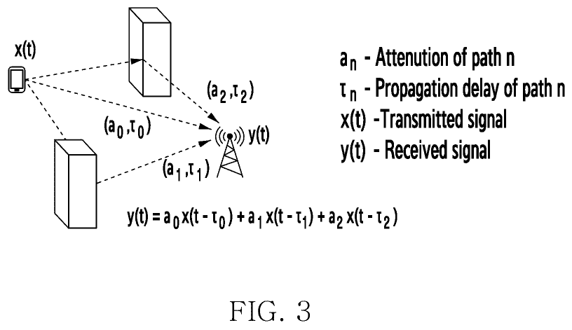

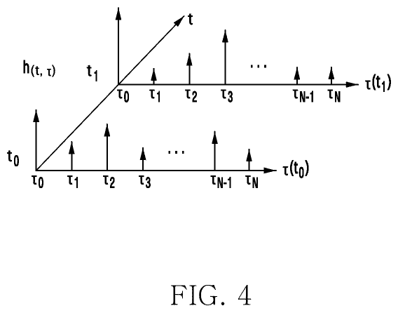

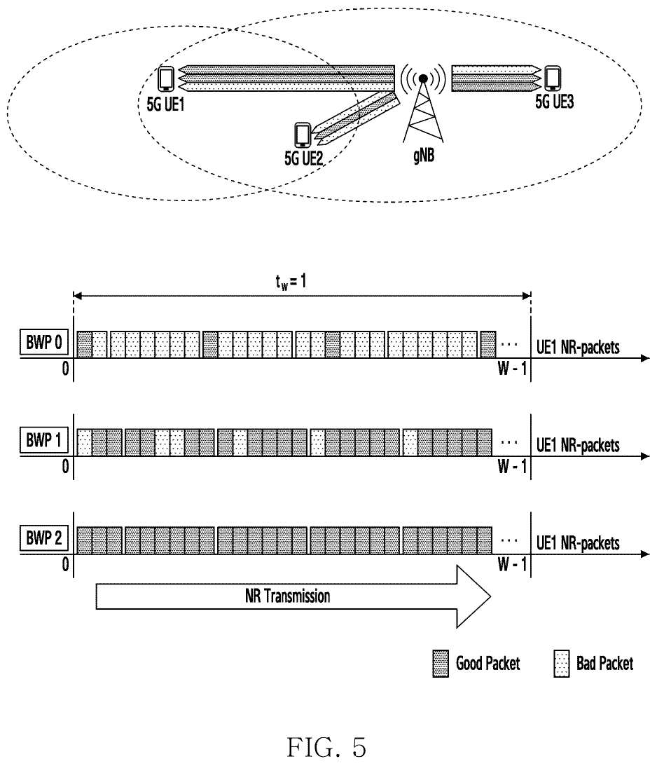

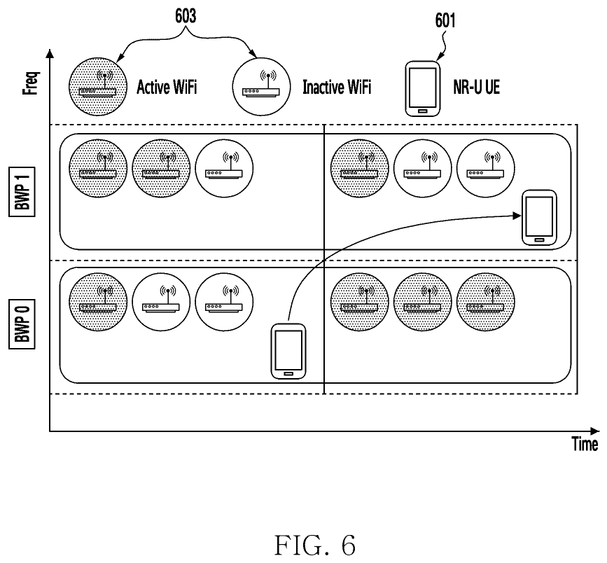

FIG. 3 illustrates a multipath reception of signals at a g NodeB (gNB) according to an embodiment of the disclosure. FIG. 4 illustrates time varying impulse response of a multipath channel according to an embodiment of the disclosure. FIG. 5 illustrates different BLER performances in each BWP in a new radio (NR) licensed system according to an embodiment of the disclosure. FIG. 6 illustrates BWP allocation in a wireless communication unlicensed system according to an embodiment of the disclosure.

Accordingly, with the introduction of BWP, a BWP assignment problem occurred in the NR-L. For example, in an urban environment, a line of sight (LOS) propagation path may or may not exist between the UE and a g-NodeB (gNB) in the 5G network. The radio waves transmitted from the UE, therefore, arrive at the gNB after reflection, also known as multipath reception, as shown in FIG. 3. The incoming radio waves from different directions have different propagation delays. This multipath reception leads to frequency-selective channels. Because of frequency selective fading, certain sub-channels can be located in deep fades in orthogonal frequency division multiplexing (OFDM), and information carried by these subcarriers is lost. Phase shifts causing destructive interference also leads to reduced signal strength. These factors can lead to increased block error rate (BLER) in certain BWPs, which directly impacts the UE's performance in that BWP. Thus, the performance of the UE can vary in different BWPs due to frequency selective fading. Further, the frequency selective performance varies with time due to the time-varying nature of the multipath channels, as shown in FIG. 4. Hence, a BWP that was giving good performance earlier may give a worse performance after some time. Thus, due to the stochastic nature of the environment, predicting the best-performing BWP is difficult and non-deterministic.

Further, UE positioning (e.g., cell edge UEs) is also an important factor that can lead to varying performance in each BWP. A UE may likely perform better in one BWP compared to others due to environmental factors and its positioning. Low performance in BWP can cause higher BLER, which results in packet retransmission. Packet retransmission results in resource wastage and lower spectrum utilization. As shown in FIG. 5, for a time window t_{w}=1, if UE1 was hypothetically assigned to each of the BWPs at the same time instant, the performance of UE1 in BWP2 would have been much better compared to BWP0 or BWP1 assignment.

The current system of choosing the BWP for a UE is based on fixed rules, such as power saving, data rate requirements, or the like, and does not consider how it may affect the overall system-level key performance indicators (KPIs). The optimal assignment of the UEs to the most appropriate BWP can improve KPIs, such as the system throughput and delay. However, the impact on overall system KPIs is not considered in legacy systems.

Similar to NR licensed spectrum, BWPs can also be defined and used in NR-U to derive similar benefits of BWPs as in the licensed case. Additionally, defining BWPs in NR-U can improve the number of NR transmission opportunities in the shared channels, leading to better network KPIs. Unlike the licensed case, the BWPs have an important factor that can determine to a large extent the performance that a BWP can serve, i.e., the collisions/congestion due to the coexisting traffic in the channels of each BWP. However, the existing system of choosing the BWP for a UE is based on fixed rules, such as power saving, data rate requirements, or the like, and does not consider how it may affect the overall system-level KPIs. The optimal assignment of the UEs to the most appropriate BWP can improve KPIs, such as the system throughput and delay. However, the impact on overall system KPIs is not considered in legacy systems. For example, as shown in FIG. 6, a given BWP may have more congestion, such as BWP0. If this is not considered and some other rule, such as the width of BWP is used or random/arbitrary assignment is used, then it may lead to a UE 601 being assigned to a BWP with a lot of traffic from other radio access technologies (RATs), such as a Wi-Fi node 603. For example, the UE 601 has been assigned to BWP0 which has more congestion compared to BWP1. This leads to very few NR transmission opportunities due to high LBT failure. In another example, if all UEs are assigned to the same given BWP, then if there are too many UEs in the BWP, each UE can get fewer opportunities to get scheduled increasing their delay. Thus, various factors need to be considered while deciding on the BWP assignment, and the existing techniques do not consider all the factors.

Thus, addressing this complex issue of BWP assignment can help greatly improve NR-U system KPIs and end-user experience. It can also better allow NR-U to leverage BWPs for flexible service provisioning, more NR transmission opportunities, or the like. The problem can be defined as follows: Consider a set of UEs that are all served by the same gNB in the NR system. In the licensed case, only the gNB and UE traffic can be considered, while in the unlicensed case, the spectrum is shared with other radio access technologies (RATs), such as Wi-Fi nodes. The spectrum of the gNB is configured into N BWPs, given by N={0, 1, 2, . . . (N−1)}. Each BWP may consist of multiple NR-U UEs and each UE is assigned to one BWP (one each for downlink (DL) and uplink UL respectively). According to existing techniques, BWP assignment policy may be considered as X_{n,u}[t]=1, i.e., UE u belongs to BWP n at time t, which is a mapping that provides the BWP ID that each UE should be assigned to.

Thus, there is a need to consider other factors as well, in addition to the power saving, and the congestion from co-existing traffic, such as the system throughput, delay, UE level traffic parameters, channel conditions, and BWP level parameters, to decide on the BWP assignment in a better manner.

Accordingly, there is a need to provide techniques for BWP assignments that overcome the above-mentioned and other related problems.

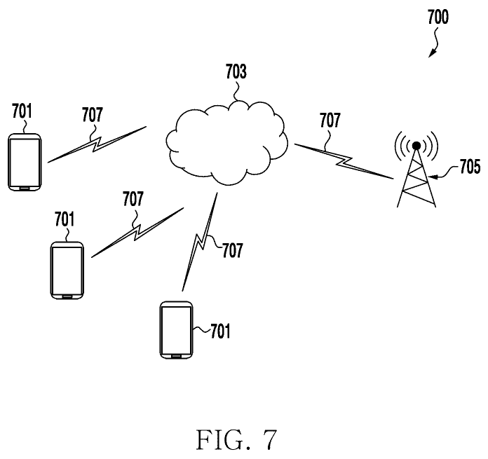

The disclosure provides techniques for managing a plurality of BWPs in a wireless communication system. Optimal BWP assignment for each UE is a must to better meet the varying quality of service (QoS) requirements of all UE which helps provide a greater end-user experience. In the unlicensed case, it also becomes more crucial as there is an inherent performance degradation due to the shared nature of spectra. Accordingly, in an embodiment of the disclosure, the disclosure discloses techniques to automatically adapt to the dynamic environments of UEs in the wireless communication system, and to provide effective BWP assignments which maximize the performance of the system as well as the UE. The disclosed techniques also ensure a proper distribution of the available UEs among the available BWPs to maximize spectrum usage. The disclosed techniques are further explained in detail with reference to FIGS. 7 to 13, 14A, 14B, 15A, and 15B.

It should be noted that for the sake of simplicity and clarity, FIGS. 7 to 13, 14A, 14B, 15A, and 15B have been explained considering the wireless communication system as a new radio (NR)/5G system. However, the techniques discussed in relation to FIGS. 7 to 13, 14A, 14B, 15A, and 15B are also applicable to other wireless communication systems, such as beyond 5G, 6G, and so on. Therefore, the terms “unlicensed NR (NR-U) system” and “licensed NR (NR-L) system” have been used interchangeably with “unlicensed wireless communication system” and “licensed wireless communication system,” respectively, throughout this disclosure and the accompanying drawings.

FIG. 7 illustrates a wireless communication system that supports managing a plurality of bandwidth parts (BWPs), according to an embodiment of the disclosure.

Referring to FIG. 7, a wireless communication system 700 may include one or more UEs 701, a core network 703, and a base station 705. In some examples, the wireless communications system 700 may be a new radio (NR) network, a 5G beyond network, a 6th generation (6G) network, or the like. In some examples, the wireless communications system 700 may support enhanced broadband communications, ultra-reliable (e.g., mission-critical) communications, low latency communications, communications with low-cost and low-complexity devices, or any combination thereof.

The base station 705 may be dispersed throughout a geographic area to form the wireless communications system 700 and may be devices in different forms or having different capabilities. The base station 705 and the one or more UEs 701 may wirelessly communicate via one or more communication links 707. Each base station 705 may provide a coverage area over which the one or more UEs 701 and the base station 705 may establish one or more communication links 707. The coverage area may be an example of a geographic area over which the base station 705 and one of the UEs 701 may support the communication of signals according to one or more radio access technologies.

The one or more UEs 701 may be dispersed throughout the coverage area of the wireless communications system 700, and each UE 701 may be stationary, mobile, or both at different times. The one or more UEs 701 may be devices in different forms or having different capabilities.

One or more of the base stations 705 described herein may include or may be referred to by a person having ordinary skill in the art as a base transceiver station, a radio base station, an access point, a radio transceiver, a NodeB, an eNodeB (eNB), a next-generation NodeB or a gNodeB (either of which may be referred to as a gNB), a home nodeB, a Home eNodeB, or other suitable terminology.

The one or more UEs 701 may include or may be referred to as a mobile device, a wireless device, a remote device, a handheld device, a subscriber device, an electronic device, or some other suitable terminology, where the “device” may also be referred to as a unit, a station, a terminal, or a client, among other examples. The one or more UEs 701 may also include or may be referred to as a personal electronic device, such as a cellular phone, a personal digital assistant (PDA), a tablet computer, a laptop computer, or a personal computer. In some examples, the one or more UEs 701 may include or be referred to as a wireless local loop (WLL) station, an Internet of things (IoT) device, an Internet of everything (IoE) device, or a machine-type communications (MTC) device, among other examples, which may be implemented in various objects, such as appliances, or vehicles, meters, among other examples.

The one or more UEs 701 described herein may be able to communicate with various types of devices, such as other UEs 701 that may sometimes act as relays as well as the base stations 705 and the network equipment including macro eNBs or gNBs, small cell eNBs or gNBs, or relay base stations, among other examples, as shown in FIG. 7.

Further, it should be noted that although only three UEs 701, and one base station 705 are depicted in FIG. 7 for illustration purposes, the wireless communication system 700 may include additional UEs and base stations not shown in FIG. 7.

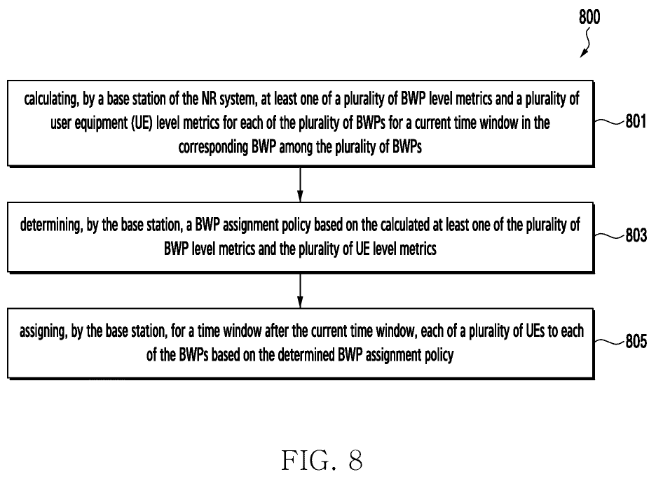

FIG. 8 illustrates a method 800 (operations) for managing a plurality of bandwidth parts (BWPs) in the wireless communication system, for example, the NR system, according to an embodiment of the disclosure. In an embodiment of the disclosure, the method 800 may be implanted in the base station 705. For example, the method 800 may be performed by the base station 705. Accordingly, in an embodiment of the disclosure, FIG. 8 has been explained in conjunction with FIG. 7.

Referring to FIG. 8, at operation 801, the method 800 may comprise calculating, by the base station 705 of the NR system at least one of a plurality of BWP level metrics and a plurality of user equipment (UE) level metrics for each of the plurality of BWPs for a current time window in the corresponding BWP among the plurality of BWPs. For example, the base station 705 may perform identifying at least one of a plurality of BWP level metrics and a plurality of user equipment (UE) level metrics for each of the plurality of BWPs for the current time window in the corresponding BWP among the plurality of BWPs. In an embodiment of the disclosure, the NR system may be an NR unlicensed (NR-U) system and may comprise a plurality of UEs. The plurality of UEs may belong to a plurality of multi-RATs operating in the same unlicensed frequency band of the NR-U system. In another embodiment of the disclosure, the NR system may be an NR licensed (NR-L) system and may comprise the plurality of UEs belonging to a single RAT operating in the NR-L system. Further, in an embodiment of the disclosure, the current time window may consist of a predefined number (W) of consecutive time slots in the corresponding BWP.

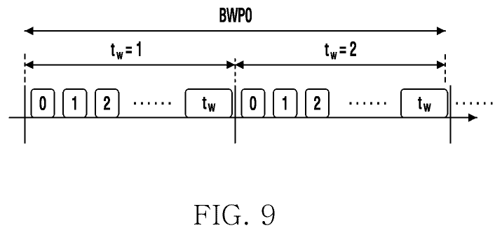

FIG. 9 illustrates a timing diagram for managing the plurality of BWPs in the wireless communication system according to an embodiment of the disclosure.

Referring to FIG. 9, in BWP0, the current time window may refer to time window 1, i.e., t_{w}=1. Accordingly, the time window 1 may comprise consecutive time slots, i.e., 0, 1, 2, . . . , W. It should be noted that the predefined numbers of consecutive time slots may be configured by the base station 705. Accordingly, the time window index t_{w}(t_{w}≥1) indicates the time interval [(t_{w}−1)·W, (t_{w}·W)−1], where W is the window size. Further, a plurality of UEs may present in each of the BWPs. For example, the plurality of UEs, such as 4 UEs may be present in BWP0. Accordingly, the UE level metrics may be calculated for each of the 4 UEs.

In an embodiment of the disclosure, when the NR system is an unlicensed NR (NR-U) system, the plurality of UE level metrics may include but is not limited to, a UE traffic queue size metric (Bᵤ[t]), a head of line (HoL) delay metric (Dᵤ[t]), an incoming packets size metric (Pᵤ[t]), an outgoing packets size metric (Lᵤ[t]), and an encoding metric (Yᵤ[t]) and UE channel conditions metric (Cᵤ[t]) of the UE. In an embodiment of the disclosure, let us consider that the plurality of UE level metrics is being calculated for the current time window 1, such as t_{w}=1 for the corresponding BWP, i.e., BWP0. Then, the base station 705 may calculate the plurality of UE level metrics for the current time window t_{w}=1. Accordingly, the UE traffic queue size metric (Bᵤ[t]) may refer to a metric containing the average traffic queue size of each of the plurality of UEs present in the current time window t_{w}=1. Similarly, the incoming packets size metric (Pᵤ[t]) may refer to a metric containing the average size of incoming packets for each of the plurality of UEs present in the current time window t_{w}=1. The outgoing packets size metric (Lᵤ[t]) may refer to a metric containing the average size of outgoing packets for each of the plurality of UEs present in the current time window t_{w}=1. The HOL delay (Dᵤ[t]) metric may refer to a metric containing the average HOL delay for each of the plurality of UEs present in the current time window t_{w}=1. The HOL delay may be defined as the average difference between the time the packet is scheduled and the time of arrival in the queue. The encoding metric (Yᵤ[t]) may refer to a metric containing the encoding scheme of each of the UEs-BWP assignments in the current time window t_{w}=1. For example, each of the plurality of UEs may be assigned to different BWPs in the current time window t_{w}=1. Accordingly, this assignment information is encoded using a predefined coding scheme, such as one hot coding scheme. It should be noted that the base station 705 may use any other coding scheme to encode the assignment information. Further, the UE channel conditions metric (Gᵤ[t]) represents an average number of bits allowed to be sent by the UE using a resource block (RB) in the current time window

In another embodiment of the disclosure, when the NR system is a licensed NR (NR-L) system, the plurality of UE level metrics may include but is not limited to, the UE traffic queue size metric (Bᵤ[t]), the HOL delay metric (Dᵤ[t]), the incoming packets size metric (Pᵤ[t]), the outgoing packets size metric (Lᵤ[t]), the encoding metric (Yᵤ[t]), the channel conditions metric (Cᵤ[t]), and a plurality of block error rate (BLER) metric (Eᵤ[t]). The UE traffic queue size metric (Bᵤ[t]), the HOL delay metric (Dᵤ[t]), the incoming packets size metric (Pᵤ[t]), the outgoing packets size metric (Lᵤ[t]), the encoding metric (Yᵤ[t]), and the UE channel conditions metric (Cᵤ[t]) are similar to that of the NR-U system. Hence, the explanation of these metrics is not provided again for the sake of brevity of the disclosure. The BLER metric (Eᵤ[t]) may refer to a metric containing BLER for each of the plurality of UEs in the current time window t_{w}=1.

In an embodiment of the disclosure, when the NR system is the NR-U system, the plurality of BWP level metrics may include but is not limited to, a listen before talk (LBT) protocol failure rate metric (Fₙ[t]), a BWP size metric (N^{RB}ₙ), an average contention window size metric (CWₙ[t_{w}]), an average incumbent channel occupancy metric (Mₙ[t_{w}]), and a channel conditions metric (Cₙ[t]). In continuation with the above example, the channel conditions metric (Cₙ[t]) represents an average number of bits allowed to be sent by each of the plurality of UEs using a resource block (RB) in the current time window t_{w}=1. Further, the LBT protocol failure rate metric (Fₙ[t]) may refer to a metric containing an average rate of failure of the LBT protocol for each of the plurality of UEs present in the current time window t_{w}=1. Each time the base station 705 attempts the LBT in the time window t_{w}=1, the number of attempts is incremented. During LBT, whenever incumbent traffic is detected, during either the ICCA or the ECCA, then the failure count is incremented. Accordingly, the LBT failure rate may be defined as:

$$Equation 1$$

$${F}_{n} [ t ] = ( \#failure \_cnt / \#lbt \_attempts ) \qquad ( 1 )$$

Similarly, the BWP size metric may refer to a metric containing the size of the corresponding BWP for each of the plurality of UEs present in the current time window t_{w}=1. The average contention window size metric (CWₙ[t_{w}]) represents the average of the contention window size during the LBT attempts started in the current time window. Further, the average incumbent channel occupancy metric (Mₙ[t_{w}]) represents the average duration for which the channel is occupied by competing technology traffic during ECCA when the NR-U's backoff counter is interrupted during ECCA, in the corresponding BWP.

In another embodiment of the disclosure, when the NR system is the NR-L system, the plurality of BWP level metrics may include but is not limited to, a plurality of block error rate (BLER) metric (Eₙ[t]) in the corresponding BWP, and a number of active UEs (Aₙ[t]) in the corresponding BWP. The BLER represents the BLER average taken across the plurality of UEs in the corresponding BWP.

It should be noted that each of the UE level and BWP level metrics may be calculated by the base station 705 using techniques known to a person skilled in the art. In another embodiment of the disclosure, some of the UE level metrics may be calculated at the UE 701 and the Base station 705 may accordingly receive them from the UE 701.

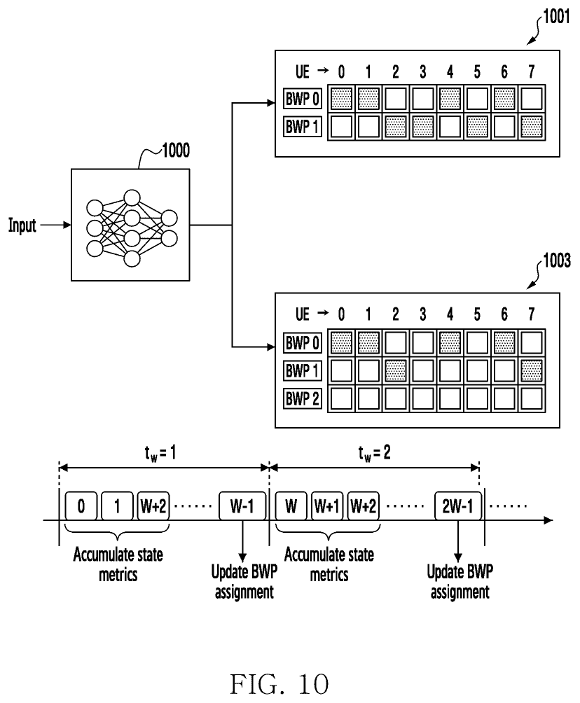

Referring back to FIG. 8, at operation 803, the method 800 may comprise determining, by the base station 705, a BWP assignment policy based on the calculated (or identified) at least one of the plurality of BWP level metrics and the plurality of UE level metrics. In an embodiment of the disclosure, the BWP assignment policy may be determined to optimize a plurality of key performance indicators (KPIs) of the NR system. In an embodiment of the disclosure, the plurality of KPIs may include throughput, HoL delay, UE power, spectral efficiency, packet delay violations, or the like. Accordingly, in an embodiment of the disclosure, the BWP assignment policy may be determined to maximize the throughput of the NR system while minimizing the HOL delay. Thereafter, at operation 805, the method 800 may comprise assigning, by the base station 705, for a time window after the current time window, each of a plurality of UEs to each of the BWPs based on the determined BWP assignment policy. For example, the current time window may be referred as a first time window and the time window after the current time window may be referred as a second time window. The method 800 is further explained in reference to FIGS. 10 to 13, 14A, 14B, 15A, and 15B.

In an embodiment of the disclosure, the BWP assignment policy may be determined using an artificial intelligence (AI) model.

FIG. 10 illustrates an AI model for managing the plurality of BWPs in the wireless communication system, such as the NR system, according to an embodiment of the disclosure.

Referring to FIG. 10, the base station 705 computes an exponentially weighted average of each of the plurality of UE level metrics and the plurality of BWP level metrics for the current time window. Then, an AI model 1000 receives the exponentially weighted average of each of the plurality of UE level metrics and the plurality of BWP level metrics from base station 705. The AI model 1000 then determines a BWP assignment policy 1001 based on the exponentially weighted average of each of the plurality of UE level metrics, the exponentially weighted average of each of the plurality of BWP level metrics, and a reward function. In an embodiment of the disclosure, the reward function is defined to maximize the throughput of the NR system and minimize the HoL delay. In an embodiment of the disclosure, as shown in FIG. 10, the AI model 1000 may receive the exponentially weighted average of each of the plurality of UE level metrics and the plurality of BWP level metrics at a time slot W−1 in the current time window t_{w}=1. Particularly, the base station 705 calculates the exponentially weighted average of each of the plurality of UE level metrics and the plurality of BWP level metrics for the current time window t_{w}=1 from time slot 0 to W−2. Then, at time slot W−1, the AI model 1000 determines the BWP assignment policy for the next time window, i.e., t_{w}=2. It should be noted that the plurality of UEs will be assigned to the corresponding BWP in the next time window t_{w}=2 according to the determined BWP assignment policy.

In an embodiment of the disclosure, when the NR system is the NR-L system, the plurality of UE level metrics includes Bᵤ[t], Dᵤ[t], Pᵤ[t], Lᵤ[t], Yᵤ[t], and Eᵤ[t], and Cᵤ[t]. Further, the plurality of BWP metrics includes Eₙ[t] and Aₙ[t]. Accordingly, the base station 705 may compute the exponentially weighted value of each of the plurality of UE level metrics and each of the plurality of BWP metrics for the current time window t_{w}=1, i.e., D̅u[t_{w}], B̅u[t_{w}], P̅u[t_{w}], L̅u[t_{w}], Y̅u[t_{w}], C̅u[t_{w}], Ēn[t_{w}], Ān[t_{w}], as defined below:

$$Equations 2 - 10$$

$$\overline{D} u [ {t}_{w} ] = ( 1 - {γ}_{d} ) \overline{D} u [ {t}_{w} ] + {γ}_{d} \overline{D} u [ {t}_{w} - 1 ] \qquad ( 2 )$$

$$\overline{B} u [ {t}_{w} ] = ( 1 - {γ}_{b} ) \overline{B} u [ {t}_{w} ] + {γ}_{b} \overline{B} u [ {t}_{w} - 1 ] \qquad ( 3 )$$

$$\overline{Y} u [ {t}_{w} ] = ( 1 - {γ}_{y} ) \overline{Y} u [ {t}_{w} ] + {γ}_{y} \overline{Y} u [ {t}_{w} - 1 ] \qquad ( 4 )$$

$$\overline{P} u [ {t}_{w} ] = ( 1 - {γ}_{p} ) \overline{P} u [ {t}_{w} ] + {γ}_{p} \overline{P} u [ {t}_{w} - 1 ] \qquad ( 5 )$$

$$\overline{L} u [ {t}_{w} ] = ( 1 - {γ}_{l} ) \overline{L} u [ {t}_{w} ] + {γ}_{l} \overline{L} u [ {t}_{w} - 1 ] \qquad ( 6 )$$

$$\overline{C} u [ {t}_{w} ] = ( 1 - {γ}_{c} ) \overline{C} u [ {t}_{w} ] + {γ}_{c} \overline{C} u [ {t}_{w} - 1 ] \qquad ( 7 )$$

$$\overline{E} u [ {t}_{w} ] = ( 1 - {γ}_{eu} ) \overline{E} u [ {t}_{w} ] + {γ}_{eu} \overline{E} u [ {t}_{w} - 1 ] \qquad ( 8 )$$

$$\overline{E} n [ {t}_{w} ] = ( 1 - {γ}_{en} ) \overline{E} n [ {t}_{w} ] + {γ}_{en} \overline{E} n [ {t}_{w} - 1 ] \qquad ( 9 )$$

$$\overline{A} n [ {t}_{w} ] = ( 1 - {γ}_{a} ) \overline{A} n [ {t}_{w} ] + {γ}_{a} \overline{A} n [ {t}_{w} - 1 ] \qquad ( 10 )$$

The respective gamma factors (γ) in each of the equations decide the weightage to be given to the historical values of the corresponding metric. After receiving the exponentially weighted value of each of the plurality of level metrics and BWP level metrics, the AI model 1000 determines the BWP assignment policy 1001. Accordingly, the AI model 1000 assigns each of the plurality of UEs to the corresponding BWP in the next time window t_{w}=2. For example, as shown in FIG. 10, UEs 0, 1, 4, and 6 have been assigned to BWP0, whereas UEs 2, 3, 5, and 7 have been assigned to BWP 1. In an embodiment of the disclosure, the AI model 1000 may be a reinforcement learning (RL) model. In such a scenario, the AI model 1000 may use a state metric to determine the BWP assignment policy. A state metric may be defined as:

$$Equation 11$$

$$S [ {t}_{w} ] = ( {⋃}_{u = 0}^{\vert U \vert - 1} {S}_{u} [ {t}_{w} ] ) ⋃ ( {⋃}_{n = 0}^{\vert N \vert - 1} {J}_{n} [ {t}_{w} ] ) \qquad ( 11 )$$

$$where ,$$

$${S}_{u} [ {t}_{w} ] = \{ \overline{D} u [ {t}_{w} ] , \overline{B} u [ {t}_{w} ] , \overline{L} u [ {t}_{w} ] , \overline{P} u [ {t}_{w} ] , \overline{E} u [ {t}_{w} ] , \overline{Y} u [ {t}_{w} ] , \overline{C} u [ {t}_{w} ] \}$$

$${J}_{n} [ {t}_{w} ] = \{ \overline{E} n [ {t}_{w} ] , \overline{A} n [ {t}_{w} ] \}$$

Further, the reward function R [t_{w}] may be defined as:

$$Equation 12$$

$${argmax}_{{x}_{n , u} [ {t}_{w} ]} R [ {t}_{w} ] \qquad ( 12 )$$

$$R [ {t}_{w} ] = - \frac{1}{\vert U \vert} {\sum }_{u} ( α {\overline{D}}_{u} [ {t}_{ω} ] + β ( {T}_{max} - {T}_{u} [ {t}_{w} ] ) )$$

Where Tₘₐₓ is the maximum achievable throughput for the NR-L system. α and β denote the weights for HoL delay and throughput respectively, and (α, β≥0). In an embodiment of the disclosure, the R[t_{w}] is determined such that the UE is assigned to one BWP only at any given time.

Further, it should be noted that the reward function is defined to optimize the KPIs of the wireless communication system, such as the NR-L system. For example, the above reward function has been configured to maximize the throughput while minimizing the HOL delay. However, the reward function can be modified easily to prioritize other KPIs. In an embodiment of the disclosure, other KPIs may include UE power, spectral efficiency, packet delay violations, or the like.

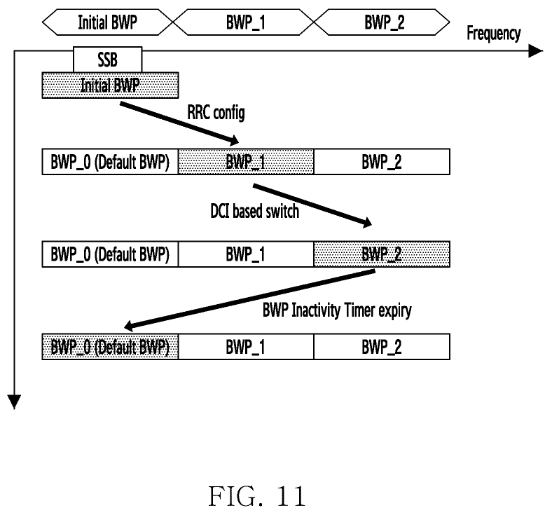

Accordingly, the plurality of UEs may be assigned to the corresponding BWPs using the AI model 1000, as depicted in FIG. 11.

FIG. 11 illustrates a BWP allocation for a wireless communication licensed system, according to an embodiment of the disclosure.

Referring to FIG. 11, during initial access, the UE captures the synchronization signal block (SSB), which contains the master information block (MIB). The UE decodes system information block 1 (SIB1) using the parameters in MIB. SIB1 contains information for Initial BWP (BWP_0) for Downlink and Uplink. The UE uses the initial BWP for uplink and the base station uses the initial BWP for downlink till radio resource control (RRC) connection between the UE and the base station. Accordingly, after the UE attaches with the NR-L system, an Initial BWP, i.e., BWP0 is assigned to each after the RRC connection is established between the UE and the base station of the NR-L system, the UE can be configured with UE-specific BWPs. The assigned BWP remains active for the current time window. Accordingly, the base station accumulates the plurality of UE level metrics and the plurality of BWP level metrics for the current time window. More particularly, the base station keeps track of each UE's performance in its assigned initial BWP and keeps collecting the UE level and BWP level metrics. At the end of the current time window, the base station passes the accumulated metrics to the AI model 1000 to determine the BWP assignment policy. If the AI model 1000 predicts the same BWP, there is no switch needed. The UE is assigned to BWP_y using a switching method, such as DCI-based BWP switching. For example, as shown in FIG. 11, the UE was assigned to BWP1 in the current time window. However, the AI model 1000 determines that the BWP2 is better for the UE, and then the UE is switched to BWP2 using the DCI switching. The base station keeps accumulating the plurality of UE level metrics and BWP level metrics till the UE is actively sending/receiving data with the base station. Accordingly, the AI model 1000 keeps determining the BWP assignment policy for the UE till the UE is actively sending/receiving data with the base station. Once the UE becomes inactive and a BWP Inactivity timer expires, the UE gets assigned back to default BWP (BWP_0).

Referring back to FIG. 10, in an embodiment of the disclosure, when the NR system is the NR-U system, the plurality of UE level metrics include the Bᵤ[t], Dᵤ[t], Pᵤ[t], Lᵤ[t], (Cᵤ[t]), and Yᵤ[t]. Further, the plurality of BWP level metrics includes the Fₙ[t], the BWP size metric (N^{RB}ₙ), CWₙ[t_{w}], (Mₙ[t]) and Cₙ[t]. In an embodiment of the disclosure, the exponentially weighted value of N^{RB}ₙ is equal to N^{RB}ₙ. In other words, the base station 705 does not calculate the exponentially weighted value of N^{RB}ₙ and forwards N^{RB}ₙ as such to the AI model 1000. Accordingly, the AI model 1000 uses the N^{RB}ₙ to determine the BWP assignment policy. Further, similar to the NR-L system, the exponentially weighted value of each of the plurality of UE level metrics and each of the plurality of BWP metrics for the current time window t_{w}=1, i.e., D̅u[t_{w}], B̅u[t_{w}], P̅u[t_{w}], L̅u[t_{w}], Yᵤ[t_{w}], F̅ₙ[t_{w}], C̅u[t_{w}], C̅Wn[t_{w}], C̅n[t_{w}], and (Mₙ[t]) are computed. It should be noted that D̅u[t_{w}], B̅u[t_{w}], Y̅u[t_{w}], P̅u[t_{w}], L̅u[t_{w}], and C̅u[t_{w}] may be determined using Equations 2, 3, 4, 5, 6, and 7 respectively. F̅n[t_{w}], C̅W̅n[t_{w}], C̅ₙ[t_{w}], and M̅n[tw] are determined as defined below:

$$Equations 13 - 16$$

$$\overline{CW} n [ {t}_{w} ] = ( 1 - {γ}_{cw} ) \overline{CW} n [ {t}_{w} ] + {γ}_{cw} \overline{CW} n [ {t}_{w} - 1 ] \qquad ( 13 )$$

$$\overline{F} n [ {t}_{w} ] = ( 1 - {γ}_{f} ) \cdot \overline{F} n [ {t}_{w} ] + {γ}_{f} \overline{F} n [ {t}_{w} - 1 ] \qquad ( 14 )$$

$$\overline{C} n [ {t}_{w} ] = ( 1 - {γ}_{cn} ) \cdot \overline{C} n [ {t}_{w} ] + {γ}_{cn} \overline{C} n [ {t}_{w} - 1 ] \qquad ( 15 )$$

$$\overline{M} n [ {t}_{w} ] = ( 1 - {γ}_{m} ) \cdot \overline{M} n [ {t}_{w} ] + {γ}_{m} \overline{M} n [ {t}_{w} - 1 ] \qquad ( 16 )$$

The respective gamma factors (γ) in each of the equations decide the weightage to be given to the historical values of the corresponding metric. After receiving the exponentially weighted value of each of the plurality of level metrics and BWP level metrics, the AI model 1000 determines a BWP assignment policy 1003. Accordingly, the AI model 1000 assigns each of the plurality of UEs to the corresponding BWP in the next time window t_{w}=2. For example, as shown in FIG. 10, UEs 0, 1, 4, and 6 have been assigned to BWP0, whereas UEs 2, and 7 have been assigned to BWP1, and UEs 3, and 5 have been assigned to BWP2. As discussed with reference to the NR-L system, the AI model 1000 may be the RL model. Accordingly, the state metric may be defined as:

$$Equation 17$$

$$S [ {t}_{w} ] = ( {⋃}_{u = 0}^{\vert U \vert - 1} {S}_{u} [ {t}_{w} ] ) ⋃ ( {⋃}_{n = 0}^{\vert N \vert - 1} {J}_{n} [ {t}_{w} ] ) \qquad ( 17 )$$

$$where ,$$

$${S}_{u} [ {t}_{w} ] = \{ \overline{D} u [ {t}_{w} ] , \overline{B} u [ {t}_{w} ] , \overline{L} u [ {t}_{w} ] , \overline{P} u [ {t}_{w} ] , \overline{E} u [ {t}_{w} ] , \overline{Y} u [ {t}_{w} ] , \overline{C} u [ {t}_{w} ] \}$$

$${J}_{n} [ {t}_{w} ] = \{ \overline{E} n [ {t}_{w} ] , \overline{A} n [ {t}_{w} ] \}$$

Further, the reward function R [t_{w}] may be defined as:

$$Equation 18$$

$${argmax}_{{x}_{n , u} [ {t}_{w} ]} R [ {t}_{w} ] \qquad ( 18 )$$

$$R [ {t}_{w} ] = - \frac{1}{\vert U \vert} {\sum }_{u} ( α {\overline{D}}_{u} [ {t}_{ω} ] + β ( {T}_{max} - {T}_{u} [ {t}_{w} ] ) )$$

Where Tₘₐₓ is the maximum achievable throughput for the NR-U system. α and β denote the weights for HoL delay and throughput respectively, and (α, β>0). In an embodiment of the disclosure, the R[t_{w}] is determined such that the UE is assigned to one BWP only at any given time. Further, it should be noted that the reward function is defined to optimize the KPIs of the wireless communication system, such as the NR-U system. For example, the above reward function has been configured to maximize the throughput while minimizing the HOL delay. However, the reward function can be modified easily to prioritize other KPIs. In an embodiment of the disclosure, other KPIs may include UE power, spectral efficiency, packet delay violations, or the like. Further, the plurality of UEs may be assigned to the corresponding BWPs using the AI model 1000, as depicted in FIG. 11.

In an alternate embodiment of the disclosure, the BWP allocation in the NR-U system may be performed by the base station 705 directly without using the AI model 1000. Such a method has been referred to as least collision assignment (LCA). However, the base station 705 can only perform the LCA for a predefined cell coverage area when the total number of active UEs in a predefined cell coverage area of the base station 705 is less than or equal to a maximum number of UEs allowed to be scheduled in per time slot in the corresponding BWP. In an embodiment of the disclosure, the predefined cell coverage area and the maximum number of UEs may be configured by the base station 705. For example, the predefined cell coverage area may be defined as the coverage area covered by one cell associated with the base station 705. In another example, the predefined cell coverage area may be defined as the coverage area covered by two cells associated with the base station 705. Further, the LCA can only be performed when the plurality of UEs are homogenous UEs with channel conditions similar to each other. For example, let us consider that the maximum number of UEs allowed to be scheduled per time slot in the corresponding BWP is 5. In this case, LCA can be performed only if the total number of active UEs in the predefined cell coverage is 5 or fewer and the signal quality between each of these UEs is similar to each other. In the LCA method, the base station 705 may compute a channel average weighted value C̅n[t_{w}] of the channel conditions based on the channel conditions metric Cn[t_{w}] for the current time window, t_{w}=1. The base station 705 may then compute an LBT average weighted value F̅n[t_{w}] of LBT failure rates based on the LBT failure rate metric Fn[t_{w}] for the current time window, t_{w}=1. The base station 705 may then determine the BWP assignment policy based on the C̅n[t_{w}], the BWP size corresponding to the BWP, and F̅n[t_{w}]. The BWP assignment policy may be determined as:

$$Equation 19$$

$$bwp *= {argmax}_{n ∈ 𝒩} ( ( 1 - {F}_{n} [ {t}_{w} - 1 ] ) \cdot {\overline{C}}_{n} [ {t}_{w} - 1 ] \cdot {N}_{n}^{RB} ) \qquad ( 19 )$$

It should be noted that C̅n[t_{w}], and F̅n[t_{w}] may be determined using Equations 11 and 12, respectively. In an embodiment of the disclosure, the BWP assignment policy may be determined to maximize the throughput of the NR-U system.

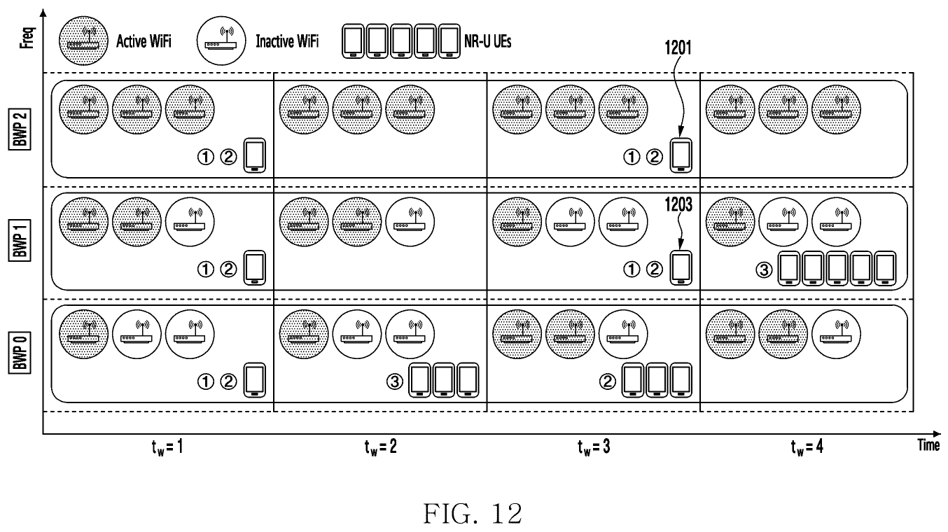

Accordingly, the plurality of UEs may be assigned to the corresponding BWPs using the LCA method, as depicted in FIG. 12.

FIG. 12 illustrates a BWP allocation for a wireless communication unlicensed system, according to an embodiment of the disclosure.

Referring to FIG. 12, when the plurality of UEs is initially attached to the base station 705, the initial BWP for each of the UEs is selected based on a Round robin manner. For example, one UE from the plurality of UEs has been assigned to each of the BWPs, i.e., BWP0, BWP1, and BWP2 for the current time window, t_{w}=1. However, as can be seen from FIG. 12, BWP2 is congested by the wi-fi nodes. In an embodiment of the disclosure, the base station 705 may calculate the plurality of BWP level metrics for each BWP. At the end of the current time window, the base station 705 may determine the BWP assignment policy, i.e., optimal BWP (bwp*), and may perform BWP reassignment based on the optimal BWP (bwp*). For example, as shown in FIG. 12, all the UEs have been assigned to BWP0 in the next time window t_{w}=2. The base station 705 may determine the BWP assignment policy for each new UE entering into the NR-U system. For example, at time window t_{w}=3, two new UEs 1201, 1203 entered into the NR-U system. Accordingly, they were initially assigned to BWP 1 and 2 for that time window t_{w}=3. During this time window, the base station 705 may determine the BWP assignment policy for the next window t_{w}=4. In case all the UEs are already attached and assigned a BWP, then the LCA method is used if the LBT Failure rate for the current optimal BWP exceeds its original value by some predefined delta value. The predefined delta value may be configured by the base station 705. For example, as shown in FIG. 12, the LBT failure rate for BWP0 exceeds its original value, accordingly, all the UEs have been assigned to BWP1 in the next time window t_{w}=4.

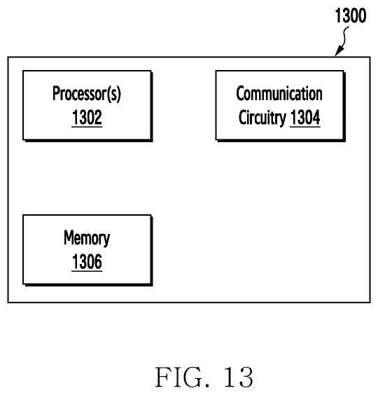

FIG. 13 illustrates a block diagram of a system for managing a plurality of BWPs in the wireless communication, such as the NR system, according to an embodiment of the disclosure.

Referring to FIG. 13, the configuration may be understood as a part of the configuration of the base station 705. Further, the method 800 as disclosed above may be implemented in a system 1300 according to a further embodiment. In an embodiment of the disclosure, the system 1300 corresponds to the UE 701. In other words, the system 1300 may be referred as the base station 705, the UE 701, a device, a network node (e.g., distributed unit (DU), near-real time RAN intelligent controller (near RT-RIC). Referring to FIG. 13, the system 1300 may include a processor 1302, communication circuitry 1304 (e.g., communicator or communication interface), and memory 1306.

As an example, the processor 1302 may be a single processing unit or a number of units, all of which could include multiple computing units. The processor 1302 may be implemented as one or more microprocessors, microcomputers, microcontrollers, digital signal processors, central processing units, state machines, logic circuitries, and/or any devices that manipulate signals based on operational instructions. Among other capabilities, the processor 1302 is configured to fetch and execute computer-readable instructions and data stored in the memory 1306. The processor 1302 may include one or a plurality of processors. At this time, one or a plurality of processors 1302 may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU). The processor or a plurality of processors 1302 may control the processing of the input data in accordance with a predefined operating rule or Artificial Intelligence (AI) model stored in the non-volatile memory and the volatile memory, i.e., the memory 1306. The predefined operating rule or AI model is provided through training or learning. In another embodiment of the disclosure, the processor 1302 may perform the method 800. For example, the processor 1302 may be referred to as at least one processor (including processing circuitry).

The processor 1302 of the system 1300 may include various processing circuits and/or a plurality of processors. For example, the term “processor” used in this document, including the claim, may include various processing circuits containing at least one processor, and one or more of the at least one processor may be configured to individually and/or collectively perform various functions described below in a distributed scheme. When “processor”, “at least one processor”, and “one or more processors” are described as being configured to perform various functions as used below, these terms are not limited to the example, and include situations in which one processor performs a part of quoted functions and another processor(s) performs another part of the quoted functions, and also situations in which one processor may perform all of the quoted functions. Additionally, for example, the at least one processor may include a combination of processors that perform various functions listed/disclosed in a distributed scheme. The at least one processor may execute program instructions to achieve or perform various functions.

The communication circuitry 1304 may perform functions for transmitting and receiving signals via a wireless channel. In an embodiment of the disclosure, the communication circuitry 1304 may assign the plurality of UEs to corresponding BWP, in accordance with techniques disclosed in the disclosure. In another embodiment of the disclosure, the processor 1302 may perform the method 800 via the communication circuitry 1304.

The memory 1306 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. For example, the memory 1306 may include one or more storage media.

Embodiments are exemplary in nature, and the system 1300 may include additional components required to implement the desired functionality of the system 1300 in accordance with the requirements of the disclosure.

In an embodiment of the disclosure, the system 1300 may be a part of a centralized unit (CU) of the NR system. In another embodiment of the disclosure, the system 1300 may be a part of a distributed unit (DU) of the NR system. In such a scenario, the system 1300 may be implemented as a part of the near-real time RAN intelligent controller (Near RT-RIC) module of the DU. The Near-RT RIC leverages embedded intelligence and is responsible for per-UE RB management, interference detection, quality of service (QoS) management, or the like. In addition, the above disclosed AI model 1000 as shown in FIG. 10 can be deployed as part of a “Trained Model” module of Near RT-RIC, where UE/Cell KPI metrics and system admin information are readily available on broader visibility across multi-RATs. Additionally, the AI model 1000 can be deployed in a separate pod within the same worker node of the DU. As the inter-node communication is easily taken care for the worker node, the DU node can pass all the statistics information to the AI model 1000, where the AI model 1000 can form the state and provide appropriate actions in each time window. These actions can then be communicated back to the DU node for the BWP reassignment.

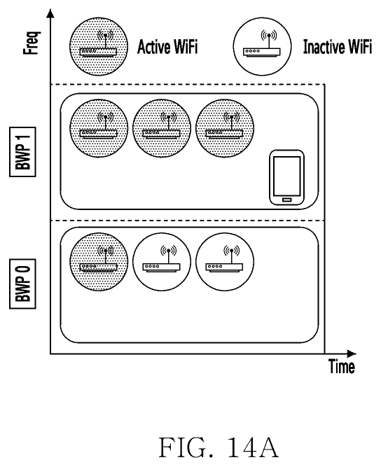

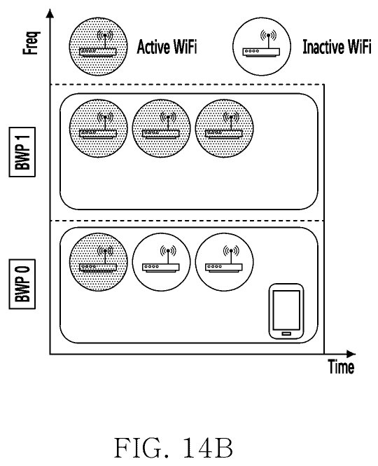

FIGS. 14A and 14B illustrate a comparison of BWP assignments in unlicensed wireless communication, such as the NR-U system, according to various embodiments of the disclosure.

Referring to FIG. 14A, in the prior art, BWP-level or UE-level metrics were not taken into account during BWP assignment for a UE, leading to suboptimal outcomes. For example, the UE might be assigned to a BWP with higher congestion due to other co-existing technologies, such as BWP1. As a result, NR's transmission opportunities are diminished, and the UE's QoS requirements are not satisfied. In contrast, referring to FIG. 14B, in an embodiment of the disclosure considers both BWP-level and UE-level metrics during BWP assignment for a UE, resulting in a more optimal assignment. For example, the UE may be assigned to a BWP with lower congestion from other co-existing technologies, such as BWP0. This leads to enhanced NR transmission opportunities and ensures that the UE's QoS requirements are met.

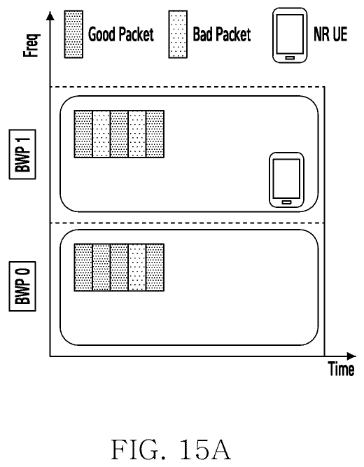

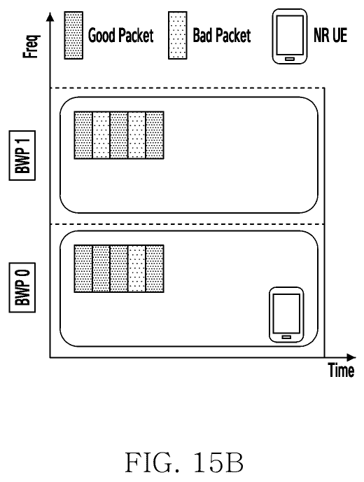

FIGS. 15A and 15B illustrate a comparison of BWP assignment in the licensed wireless communication system, such as the NR-L system, according to various embodiments of the disclosure.

Referring to FIG. 15A, in the prior art, BWP level or UE level metrics were not taken into account during BWP assignment for a UE, leading to suboptimal outcomes. For example, the UE might be assigned to a BWP with more BLER, such as BWP1. This results in more packet retransmission indicating resource wastage and reduced spectral efficiency. In addition, the UE's QoS requirements are not satisfied. In contrast, referring to FIG. 15B, in an embodiment of the disclosure considers both BWP-level and UE-level metrics during BWP assignment for a UE, resulting in a more optimal assignment. For example, the UE may be assigned to a BWP with a lower BLER, such as BWP0. This results in lesser packet retransmission indicating lesser resource wastage and improved spectral efficiency. In addition, the UE's QoS requirements are met.

Accordingly, the disclosure provides techniques for managing the plurality of BWPs in the NR system.

Accordingly, the disclosure provides various advantages. For example, the disclosure provides techniques to optimize the unlicensed channel access for NR, while reducing the average HOL delay for UEs and increasing the cell throughput. In addition, with the use of the AI-based model for BWP assignment, the disclosed techniques help in jointly optimizing and producing a BWP assignment recommendation at every time window. Further, the disclosure provides a mechanism to automatically adapt to the dynamic environments of UEs in NR and to provide effective BWP assignments that maximize the performance of the NR system as well as the UE. The disclosed techniques also ensure that the fairness of spectrum usage is maintained and does not hamper the performance of coexisting technologies. The disclosed techniques improve KPIs, such as throughput and delay for both the overall NR system and individual UEs. In an embodiment of the disclosure, the disclosed techniques reduce the HOL delay by 35-70% and increase the throughput by 15-75%. The disclosed techniques also result in enhanced customer satisfaction, greater SLA compliance, improved quality of service, and reduced network maintenance costs. As fairness is maintained in coexistence, the disclosed techniques ensure regulatory compliance as well.

According to embodiments of the disclosure, a method 800 for managing a plurality of bandwidth parts (BWPs) in a wireless communication system may comprise calculating 801, by a base station of the wireless communication system, at least one of a plurality of BWP level metrics and a plurality of user equipment (UE) level metrics for each of the plurality of BWPs for a current time window in the corresponding BWP among the plurality of BWPs. The method 800 may comprise determining 803, by the base station, a BWP assignment policy based on the calculated at least one of the plurality of BWP level metrics and the plurality of UE level metrics. The method 800 may comprise assigning 805, by the base station, for a time window after the current time window, each of a plurality of UEs to each of the BWPs based on the determined BWP assignment policy.

In an embodiment of the disclosure, the BWP assignment policy may be determined to optimize a plurality of key performance indicators (KPIs) of the wireless communication system.

In an embodiment of the disclosure, when the wireless communication system is an unlicensed wireless communication system, the plurality of UE level metrics may include a UE traffic queue size metric, a head of line (HoL) delay metric, an incoming packets size metric, an outgoing packets size metric, a UE channel conditions metric, and an encoding metric. The UE channel conditions metric may represent an average number of bits allowed to be sent by the UE using a resource block (RB) in the current time window. The encoding metric may represent encoding scheme for encoding assignment of each of the UEs to the corresponding BWP.

In an embodiment of the disclosure, when the wireless communication system is a licensed wireless communication system, the plurality of UE level metrics may include a UE traffic queue size metric, a head of line (HoL) delay metric, an incoming packets size metric, an outgoing packets size metric, an encoding metric, a UE channel conditions metric, and a plurality of block error rate (BLER) metric.

In an embodiment of the disclosure, when the wireless communication system is a licensed wireless communication system, the plurality of BWP level metrics may include a plurality of block error rate (BLER) metric in the corresponding BWP and a number of active UEs in the corresponding BWP.

In an embodiment of the disclosure, determining the BWP assignment policy may comprise computing an exponentially weighted average of each of the plurality of UE level metrics and the plurality of BWP level metrics for the current time window. Determining the BWP assignment policy may comprise determining the BWP assignment policy based on the exponentially weighted average of each of the plurality of UE level metrics, the exponentially weighted average of each of the plurality of BWP level metrics, and a reward function.

In an embodiment of the disclosure, the reward function may be defined to optimize a plurality of KPIs of the wireless communication system. The wireless communication system may be one of an unlicensed wireless communication system and a licensed wireless communication system.

In an embodiment of the disclosure, determining the BWP assignment policy may comprise determining the BWP assignment policy using an artificial intelligence (AI) model.

In an embodiment of the disclosure, when the wireless communication system is an unlicensed wireless communication system, the plurality of BWP level metrics may include a listen before talk (LBT) protocol failure rate metric, a BWP size metric, an average contention window size metric, an average incumbent channel occupancy metric, and a channel conditions metric. The channel conditions metric may represent an average number of bits allowed to be sent by each of the plurality of UEs using a resource block (RB) in the current time window of the corresponding BWP.

In an embodiment of the disclosure, when the wireless communication system is an unlicensed wireless communication system, determining the BWP assignment policy may comprise computing a channel average weighted value of channel conditions based on the channel conditions metric for the current time window. When the wireless communication system is an unlicensed wireless communication system, determining the BWP assignment policy may comprise computing an LBT average weighted value of LBT failure rates based on the LBT failure rate metric for the current time window. When the wireless communication system is an unlicensed wireless communication system, determining the BWP assignment policy may comprise determining the BWP assignment policy based on the channel average weighted value the LBT average weighted value, and a BWP size corresponding to the BWP. The BWP assignment policy may be determined to optimize a plurality of KPIs of the unlicensed wireless communication system.

In an embodiment of the disclosure, the plurality of BWP level metrics may include a listen before talk (LBT) protocol failure rate metric, a BWP size metric, and a channel conditions metric. The channel conditions metric may represent an average number of bits allowed to be sent by each of the plurality of UEs using a resource block (RB) in the current time window of the corresponding BWP.

In an embodiment of the disclosure, determining the BWP assignment policy may comprise determining the BWP assignment policy when a total number of active UEs in a predefined cell coverage area of the base station being less than or equal to a maximum number of UEs allowed to be scheduled per time slot in the corresponding BWP.

In an embodiment of the disclosure, determining the BWP assignment policy may comprise determining the BWP assignment policy when the plurality of UEs are homogenous UEs with channel conditions similar to each other.

In an embodiment of the disclosure, the current time window may consist of a predefined number of consecutive time slots in the corresponding BWP.

In an embodiment of the disclosure, the plurality of UEs may belong to one of a plurality of multi radio access technologies (RATs) operating in the same unlicensed frequency band of an unlicensed wireless communication system and a single RAT operating in a licensed wireless communication system.

According to embodiments of the disclosure, a system 1300 for managing a plurality of bandwidth parts (BWPs) in a wireless communication system may comprise memory 1306. The system 1300 may comprise a processor 1301 coupled to the memory 1306. The processor 1301 may be configured to calculate at least one of a plurality of BWP level metrics and a plurality of user equipment (UE) level metrics for each of the plurality of BWPs for a current time window in the corresponding BWP among the plurality of BWPs. The processor 1301 may be determine a BWP assignment policy based on the calculated at least one of the plurality of BWP level metrics and the plurality of UE level metrics. The processor 1301 may be assign, for a time window after the current time window, each of a plurality of UEs to each of the BWPs based on the determined BWP assignment policy.

In an embodiment of the disclosure, the BWP assignment policy may be determined to optimize a plurality of key performance indicators (KPIs) of the wireless communication system.

In an embodiment of the disclosure, when the wireless communication system is an unlicensed wireless communication system, the plurality of UE level metrics may include a UE traffic queue size metric, a head of line (HoL) delay metric, an incoming packets size metric, an outgoing packets size metric, a UE channel conditions metric, and an encoding metric. The UE channel conditions metric may represent an average number of bits allowed to be sent by the UE using a resource block (RB) in the current time window. The encoding metric may represent encoding scheme for encoding assignment of each of the UEs to the corresponding BWP.

In an embodiment of the disclosure, when the wireless communication system is a licensed wireless communication system, the plurality of UE level metrics may include a UE traffic queue size metric, a head of line (HoL) delay metric, an incoming packets size metric, an outgoing packets size metric, an encoding metric, a UE channel conditions metric, and a plurality of block error rate (BLER) metric corresponding to each of the plurality of UEs.

In an embodiment of the disclosure, when the wireless communication system is a licensed wireless communication system, the plurality of BWP level metrics may include a plurality of block error rate (BLER) metric in the corresponding BWP and a number of active UEs in the corresponding BWP.

In an embodiment of the disclosure, for determining the BWP assignment policy, the processor 1301 is configured to compute an exponentially weighted average of each of the plurality of UE level metrics and the plurality of BWP level metrics for the current time window. For determining the BWP assignment policy, the processor 1301 is configured to determine the BWP assignment policy based on the exponentially weighted average of each of the plurality of UE level metrics, the exponentially weighted average of each of the plurality of BWP level metrics, and a reward function.

In an embodiment of the disclosure, the reward function may be defined to optimize a plurality of KPIs of the wireless communication system. The wireless communication system may be one of an unlicensed wireless communication system and a licensed wireless communication system.

In an embodiment of the disclosure, the processor 1301 may be configured to determine the BWP assignment policy using an artificial intelligence (AI) model.

In an embodiment of the disclosure, when the wireless communication system is an unlicensed wireless communication system, the plurality of BWP level metrics may include a listen before talk (LBT) protocol failure rate metric an average contention window size metric, an average incumbent channel occupancy metric, and a channel conditions metric. The channel conditions metric may represent an average number of bits allowed to be sent by each of the plurality of UEs using a resource block (RB) in the current time window of the corresponding BWP.

In an embodiment of the disclosure, when the wireless communication system is an unlicensed wireless communication system, for determining the BWP assignment policy, the processor 1301 is configured to compute a channel average weighted value of channel conditions based on the channel conditions metric for the current time window. When the wireless communication system is an unlicensed wireless communication system, for determining the BWP assignment policy, the processor 1301 is configured to compute an LBT average weighted value of LBT failure rates based on the LBT failure rate metric for the current time window. When the wireless communication system is an unlicensed wireless communication system, for determining the BWP assignment policy, the processor 1301 is configured to determine the BWP assignment policy based on the channel average weighted value, a BWP size corresponding to the BWP, and the LBT average weighted value. The BWP assignment policy may be determined to optimize a plurality of KPIs of the unlicensed wireless communication system.

In an embodiment of the disclosure, the plurality of BWP level metrics may include a listen before talk (LBT) protocol failure rate metric, a BWP size metric, and a channel conditions metric. The channel conditions metric may represent an average number of bits allowed to be sent by each of the plurality of UEs using a resource block (RB) in the current time window of the corresponding BWP.

In an embodiment of the disclosure, the processor 1301 may be configured to determine the BWP assignment policy when a total number of active UEs in a predefined cell coverage area of the base station being less than or equal to a maximum number of UEs allowed to be scheduled per time slot in the corresponding BWP.

In an embodiment of the disclosure, the processor 1301 may be configured to determine the BWP assignment policy when the plurality of UEs are homogenous UEs with channel conditions similar to each other.

In an embodiment of the disclosure, the current time window may consist of a predefined number of consecutive time slots in the corresponding BWP.

In an embodiment of the disclosure, the plurality of UEs may belong to a plurality of multi radio access technologies (RATs) operating in one of a same unlicensed frequency band of an unlicensed wireless communication system and a single RAT operating in a licensed wireless communication system.

According to embodiments of the disclosure, a method performed by a base station in a wireless communication system may comprise identifying at least one of a plurality of bandwidth part (BWP) level metrics and a plurality of user equipment (UE) level metrics for each of a plurality of BWPs for a first time window in corresponding BWP from among the plurality of BWPs. The method may comprise determining a BWP assignment policy based on the identified at least one of the plurality of BWP level metrics and the plurality of UE level metrics. The method may comprise assigning for a second time window after the first time window, each of a plurality of UEs to each of the BWPs based on the determined BWP assignment policy.

In an embodiment of the disclosure, the BWP assignment policy may be determined to optimize a plurality of key performance indicators (KPIs) of the wireless communication system.

In an embodiment of the disclosure, in case that the wireless communication system is an unlicensed system, the plurality of UE level metrics may include a UE traffic queue size metric, a head of line (HoL) delay metric, an incoming packets size metric, an outgoing packets size metric, a UE channel conditions metric, and an encoding metric. The UE channel conditions metric may represent an average number of bits allowed to be sent by each of the plurality of UEs using a resource block (RB) in the first time window. The encoding metric may represent encoding scheme for encoding assignment of each of the plurality of UEs to the corresponding BWP.

In an embodiment of the disclosure, in case that the wireless communication system is a licensed system, the plurality of UE level metrics may include a UE traffic queue size metric, a head of line (HoL) delay metric, an incoming packets size metric, an outgoing packets size metric, an encoding metric, a UE channel conditions metric, and a plurality of block error rate (BLER) metric.

In an embodiment of the disclosure, in case that the wireless communication system is a licensed system, the plurality of BWP level metrics may include a plurality of block error rate (BLER) metric in the corresponding BWP and a number of active UEs in the corresponding BWP.

In an embodiment of the disclosure, the determining the BWP assignment policy may further comprise calculating an exponentially weighted average of each of the plurality of UE level metrics and the plurality of BWP level metrics for the first time window. The determining the BWP assignment policy may further comprise determining the BWP assignment policy based on the exponentially weighted average of each of the plurality of UE level metrics, the exponentially weighted average of each of the plurality of BWP level metrics, and a reward function.

In an embodiment of the disclosure, the reward function may be defined to optimize a plurality of KPIs of the wireless communication system. The wireless communication system may be one of an unlicensed system and a licensed system.

In an embodiment of the disclosure, the determining the BWP assignment policy may further comprise determining the BWP assignment policy using an artificial intelligence (AI) model.

In an embodiment of the disclosure, in case that the wireless communication system is an unlicensed system, the plurality of BWP level metrics may include a listen before talk (LBT) protocol failure rate metric, a BWP size metric, an average contention window size metric, an average incumbent channel occupancy metric, and a channel conditions metric. The channel conditions metric may represent an average number of bits allowed to be sent by each of the plurality of UEs using a resource block (RB) in the first time window of the corresponding BWP in an embodiment.

In an embodiment of the disclosure, in case that the wireless communication system is an unlicensed system, the determining the BWP assignment policy may further comprise calculating a channel average weighted value of channel conditions based on the channel conditions metric for the first time window. In case that the wireless communication system is an unlicensed system, the determining the BWP assignment policy may further comprise calculating an LBT average weighted value of LBT failure rates based on the LBT failure rate metric for the first time window. In case that the wireless communication system is an unlicensed system, the determining the BWP assignment policy may further comprise determining the BWP assignment policy based on the channel average weighted value the LBT average weighted value, and a BWP size of the corresponding BWP. The BWP assignment policy may be determined to optimize a plurality of KPIs of the unlicensed system.

In an embodiment of the disclosure, the plurality of BWP level metrics may include a listen before talk (LBT) protocol failure rate metric, a BWP size metric, and a channel conditions metric. The channel conditions metric may represent an average number of bits allowed to be sent by each of the plurality of UEs using a resource block (RB) in the first time window of the corresponding BWP.

In an embodiment of the disclosure, the determining the BWP assignment policy may further comprise determining the BWP assignment policy when a total number of active UEs in a predefined cell coverage area of the base station being less than or equal to a maximum number of UEs allowed to be scheduled per time slot in the corresponding BWP.

In an embodiment of the disclosure, the first time window may consist of a predefined number of consecutive time slots in the corresponding BWP.

According to embodiments of the disclosure, a base station may comprise memory storing instructions. The base station may comprise at least one processor. The instructions, when executed by the at least one processor individually or collectively, may cause the base station to identify at least one of a plurality of bandwidth part (BWP) level metrics and a plurality of user equipment (UE) level metrics for each of a plurality of BWPs for a first time window in corresponding BWP from among the plurality of BWPs. The instructions, when executed by the at least one processor individually or collectively, may cause the base station to determine a BWP assignment policy based on the identified at least one of the plurality of BWP level metrics and the plurality of UE level metrics. The instructions, when executed by the at least one processor individually or collectively, may cause the base station to assign for a second time window after the first time window, each of a plurality of UEs to each of the BWPs based on the determined BWP assignment policy.

According to embodiments of the disclosure, a non-transitory computer-readable storage medium, when individually or collectively executed by at least one processor of a base station, may store one or more programs including instructions that cause the base station to identify at least one of a plurality of bandwidth part (BWP) level metrics and a plurality of user equipment (UE) level metrics for each of a plurality of BWPs for a first time window in corresponding BWP from among the plurality of BWPs. The non-transitory computer-readable storage medium, when individually or collectively executed by the at least one processor, may store one or more programs including instructions that cause the base station to determine a BWP assignment policy based on the identified at least one of the plurality of BWP level metrics and the plurality of UE level metrics. The non-transitory computer-readable storage medium, when individually or collectively executed by the at least one processor, may store one or more programs including instructions that cause the base station to assign for a second time window after the first time window, each of a plurality of UEs to each of the BWPs based on the determined BWP assignment policy.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station in a wireless communication system, the method comprising:
identifying at least one of a plurality of bandwidth part (BWP) level metrics and a plurality of user equipment (UE) level metrics for each of a plurality of BWPs for a first time window in corresponding BWP from among the plurality of BWPs;
determining a BWP assignment policy based on the identified at least one of the plurality of BWP level metrics and the plurality of UE level metrics; and
assigning for a second time window after the first time window, each of a plurality of UEs to each of the BWPs based on the determined BWP assignment policy.

2. The method of claim 1, wherein the BWP assignment policy is determined to optimize a plurality of key performance indicators (KPIs) of the wireless communication system.

3. The method of claim 1,
wherein, in case that the wireless communication system is an unlicensed system, the plurality of UE level metrics include:
a UE traffic queue size metric;
a head of line (HoL) delay metric;
an incoming packets size metric;
an outgoing packets size metric;
a UE channel conditions metric; and
an encoding metric,
wherein the UE channel conditions metric represents an average number of bits allowed to be sent by each of the plurality of UEs using a resource block (RB) in the first time window, and
wherein the encoding metric represents encoding scheme for encoding assignment of each of the plurality of UEs to the corresponding BWP.

4. The method of claim 1, wherein, in case that the wireless communication system is a licensed system, the plurality of UE level metrics include:
a UE traffic queue size metric;
a head of line (HoL) delay metric;
an incoming packets size metric;
an outgoing packets size metric;
an encoding metric;
a UE channel conditions metric; and
a plurality of block error rate (BLER) metric.

5. The method of claim 1, wherein, in case that the wireless communication system is a licensed system, the plurality of BWP level metrics include:
a plurality of block error rate (BLER) metric in the corresponding BWP; and
a number of active UEs in the corresponding BWP.

6. The method of claim 1, wherein the determining of the BWP assignment policy further comprises:
calculating an exponentially weighted average of each of the plurality of UE level metrics and the plurality of BWP level metrics for the first time window; and
determining the BWP assignment policy based on the exponentially weighted average of each of the plurality of UE level metrics, the exponentially weighted average of each of the plurality of BWP level metrics, and a reward function.

7. The method of claim 6,
wherein the reward function is defined to optimize a plurality of KPIs of the wireless communication system, and
wherein the wireless communication system is one of an unlicensed system and a licensed system.

8. The method of claim 6, wherein the determining of the BWP assignment policy further comprises:
determining the BWP assignment policy using an artificial intelligence (AI) model.

9. The method of claim 6,
wherein, in case that the wireless communication system is an unlicensed system, the plurality of BWP level metrics include:
a listen before talk (LBT) protocol failure rate metric,
a BWP size metric,
an average contention window size metric,
an average incumbent channel occupancy metric, and
a channel conditions metric, and
wherein the channel conditions metric represents an average number of bits allowed to be sent by each of the plurality of UEs using a resource block (RB) in the first time window of the corresponding BWP.

10. The method of claim 1, wherein, in case that the wireless communication system is an unlicensed system, the determining of the BWP assignment policy further comprises:
calculating a channel average weighted value of channel conditions based on the channel conditions metric for the first time window;
calculating an LBT average weighted value of LBT failure rates based on the LBT failure rate metric for the first time window; and
determining the BWP assignment policy based on the channel average weighted value the LBT average weighted value, and a BWP size of the corresponding BWP, wherein the BWP assignment policy is determined to optimize a plurality of KPIs of the unlicensed system.

11. The method of claim 10,
wherein the plurality of BWP level metrics include:
a listen before talk (LBT) protocol failure rate metric;
a BWP size metric; and
a channel conditions metric, and
wherein the channel conditions metric represents an average number of bits allowed to be sent by each of the plurality of UEs using a resource block (RB) in the first time window of the corresponding BWP.

12. The method of claim 10, wherein the determining of the BWP assignment policy further comprises:
determining the BWP assignment policy when a total number of active UEs in a predefined cell coverage area of the base station being less than or equal to a maximum number of UEs allowed to be scheduled per time slot in the corresponding BWP.

13. The method of claim 1, wherein the first time window consists of a predefined number of consecutive time slots in the corresponding BWP.

14. A base station comprising:
memory, comprising one or more storage media, storing instructions; and
at least one processor,
wherein the instructions, when executed by the at least one processor individually or collectively, cause the base station to:
identify at least one of a plurality of bandwidth part (BWP) level metrics and a plurality of user equipment (UE) level metrics for each of a plurality of BWPs for a first time window in corresponding BWP from among the plurality of BWPs,
determine a BWP assignment policy based on the identified at least one of the plurality of BWP level metrics and the plurality of UE level metrics, and
assign for a second time window after the first time window, each of a plurality of UEs to each of the BWPs based on the determined BWP assignment policy.

15. The base station of claim 14, wherein the BWP assignment policy is determined to optimize a plurality of key performance indicators (KPIs) of a wireless communication system.

16. The base station of claim 14,
wherein, in case that a wireless communication system is an unlicensed system, the plurality of UE level metrics include:
a UE traffic queue size metric;
a head of line (HoL) delay metric;
an incoming packets size metric;
an outgoing packets size metric;
a UE channel conditions metric; and
an encoding metric,
wherein the UE channel conditions metric represents an average number of bits allowed to be sent by each of the plurality of UEs using a resource block (RB) in the first time window, and
wherein the encoding metric represents encoding scheme for encoding assignment of each of the plurality of UEs to the corresponding BWP.

17. The base station of claim 15, wherein, in case that the wireless communication system is a licensed system, the plurality of UE level metrics include:
a UE traffic queue size metric;
a head of line (HoL) delay metric;
an incoming packets size metric;
an outgoing packets size metric;
an encoding metric;
a UE channel conditions metric; and
a plurality of block error rate (BLER) metric.

18. The base station of claim 15, wherein, in case that the wireless communication system is a licensed system, the plurality of BWP level metrics include:
a plurality of block error rate (BLER) metric in the corresponding BWP; and
a number of active UEs in the corresponding BWP.

19. One or more non-transitory computer-readable storage media storing one or more computer programs including computer-executable instruction that, when executed by at least one processor of a base station in a wireless communication system individually or collectively, cause the base station to perform operations, the operations comprising:
identifying at least one of a plurality of bandwidth part (BWP) level metrics and a plurality of user equipment (UE) level metrics for each of a plurality of BWPs for a first time window in corresponding BWP from among the plurality of BWPs;
determining a BWP assignment policy based on the identified at least one of the plurality of BWP level metrics and the plurality of UE level metrics; and
assigning for a second time window after the first time window, each of a plurality of UEs to each of the BWPs based on the determined BWP assignment policy.

20. The one or more non-transitory computer-readable storage media of claim 19, wherein the BWP assignment policy is determined to optimize a plurality of key performance indicators (KPIs) of the wireless communication system.
